(19) United States
(12) Patent Application Publication
(10) Pub. No.: US 2018/0126907 A1
(43) Pub. Date: May 10, 2018

(54) CAMERA-BASED SYSTEM FOR REDUCING REFLECTIVITY OF A REFLECTIVE SURFACE

(71) Applicant: Faraday&Future Inc., Gardena, CA (US)

(72) Inventors: Oliver Max Jeromin, Torrance, CA (US); Evan Roger Fischer, Torrance, CA (US); Hong S. Bae, Torrance, CA (US)

(21) Appl. No.: 15/632,244

(22) Filed: Jun. 23, 2017

Related U.S. Application Data
(60) Provisional application No. 62/354,593, filed on Jun. 24, 2016.

(51) Int. Cl. B60R 1/00; G06K 9/00

(52) U.S. Cl. CPC B60R 1/006; B60R 1/00; B60R 2300/8046; B60R 2300/105; B60R 2300/30; G06K 9/00825

(57) ABSTRACT

A vehicle includes one or more dimmable mirrors, one or more cameras configured to capture images of surroundings of the vehicle, and one or more processors coupled to the one or more dimmable mirrors and the one or more cameras. The one or more processors are configured to identify one or more headlights of another vehicle in the captured images, determine whether the one or more headlights satisfy mirror dimming criteria, including a criterion that is satisfied when the one or more headlights are located in a respective region of the captured images, in accordance with a determination that the one or more headlights satisfy the mirror dimming criteria, dim the dimmable mirrors based on one or more characteristics of the one or more headlights, and in accordance with a determination that the one or more headlights do not satisfy the mirror dimming criteria, forgo dimming the dimmable mirrors.

### CROSS-REFERENCE TO RELATED APPLICATIONS

This application claims the benefit of U.S. Provisional Application No. 62/354,593, filed Jun. 24, 2016, the entirety of which is hereby incorporated by reference.

### FIELD OF THE DISCLOSURE

This relates generally to reducing the reflectivity of a reflective surface (e.g., dimming one or more mirrors on a vehicle), and more particularly to doing so based on images captured by one or more cameras.

### BACKGROUND OF THE DISCLOSURE

Vehicles, especially automobiles, increasingly include various internal or external cameras for enhancing drivers' or passengers' experiences in the vehicles. Sometimes, these cameras replace or augment the functionality of physical mirrors on the vehicle.

### SUMMARY OF THE DISCLOSURE

Examples of the disclosure are directed to using one or more cameras on a vehicle to dynamically dim one or more mirrors (e.g., side view mirrors) on the vehicle to prevent or reduce glare, for the driver of the vehicle, caused by reflections of light (e.g., from headlights of trailing vehicles) from those mirrors.

### BRIEF DESCRIPTION OF THE DRAWINGS

FIG. 1 illustrates an exemplary mirror dimming system according to examples of the disclosure.

FIG. 2 illustrates an exemplary vehicle that does not include a rear view mirror according to examples of the disclosure.

FIGS. 3A-3C illustrate exemplary composite images captured by one or more cameras described in FIG. 2 according to examples of the disclosure.

FIG. 3D illustrates an example face of the driver of the vehicle according to examples of the disclosure.

FIG. 4 illustrates an exemplary method for dimming the side view mirrors of a vehicle based on images captured by one or more cameras according to examples of the disclosure.

FIG. 5 illustrates an exemplary system block diagram of a vehicle control system according to examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

Vehicles, especially automobiles, increasingly include various internal or external cameras for enhancing drivers' or passengers' experiences in the vehicles. Sometimes, these cameras replace or augment the functionality of physical mirrors on the vehicle. Examples of the disclosure are directed to using one or more cameras on a vehicle to dynamically dim one or more mirrors (e.g., side view mirrors) on the vehicle to prevent or reduce glare, for the driver of the vehicle, caused by reflections of light (e.g., from headlights of trailing vehicles) from those mirrors.

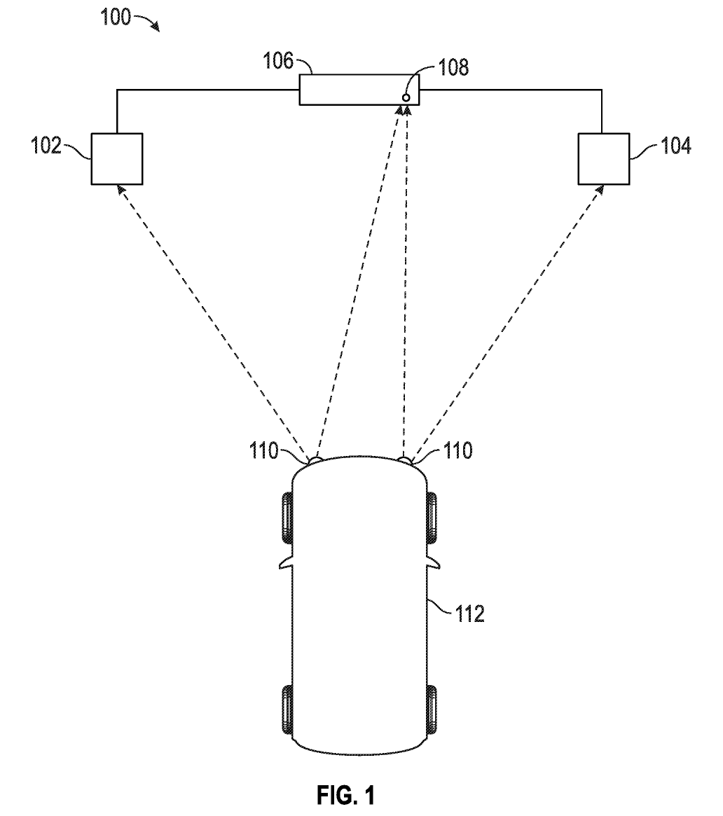

FIG. 1 illustrates an exemplary mirror dimming system 100 according to examples of the disclosure. Mirror dimming system 100 can correspond to a dimming system in a vehicle that includes a left side view mirror 102, a right side view mirror 104 and a rear view mirror 106. Rear view mirror 106 can include an optoelectronic diode 108, which can sense light incident upon it, and generate a voltage in response. One or more of left side view mirror 102, right side view mirror 104 and rear view mirror 106 can dim so as to reduce glare, for the driver of the vehicle, from the headlights of another vehicle (e.g., a trailing vehicle). Specifically, left side view mirror 102, right side view mirror 104 and/or rear view mirror 106 can be electrochromic, and can darken in response to a voltage applied to them, thus reducing discomfort to the driver of the vehicle from reflections of headlights of other vehicles from one or more of left side view mirror 102, right side view mirror 104 and rear view mirror 106. Dimming in system 100 can be performed in response to optoelectronic diode 108 detecting light incident upon it from, for example, headlights 110 of a trailing vehicle 112. If optoelectronic diode 108 detects such light incident upon it, it can transmit a corresponding signal (e.g., a voltage) to a controller of the vehicle to dim the rear view 106 and/or side view 102, 104 mirrors according to the signal.

However, in some circumstances, one or more of mirrors 102, 104 and 106 on the vehicle may be replaced by camera and display systems in which, in lieu of mirrors, one or more cameras can capture images of the vehicle's surroundings (e.g., sides and rear), and one or more displays in the vehicle can display those images inside the vehicle for the driver's reference. For example, a vehicle may not include rear view mirror 106 (but may continue to include side view mirrors 102 and 104 due to safety regulations, for example), instead including a rear view camera and a display inside the vehicle that displays images from the rear view camera, the images corresponding to what may have been visible to the driver via a rear view mirror. Because the vehicle may no longer include a rear view mirror, the vehicle may no longer have available to it a location for including optoelectronic diode 108. However, because the vehicle can continue to include side view mirrors 102 and 104, the risk of glare for the driver of the vehicle from trailing headlights can remain. Thus, an alternative solution for detecting trailing headlights is needed to dim side view mirrors 102 and 104 to continue to reduce glare for the driver of the vehicle.

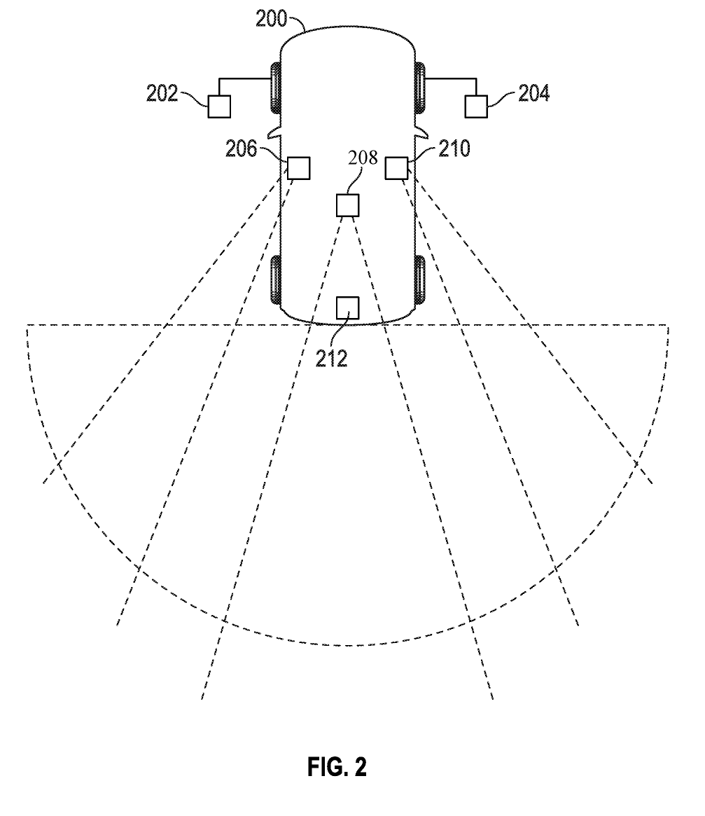

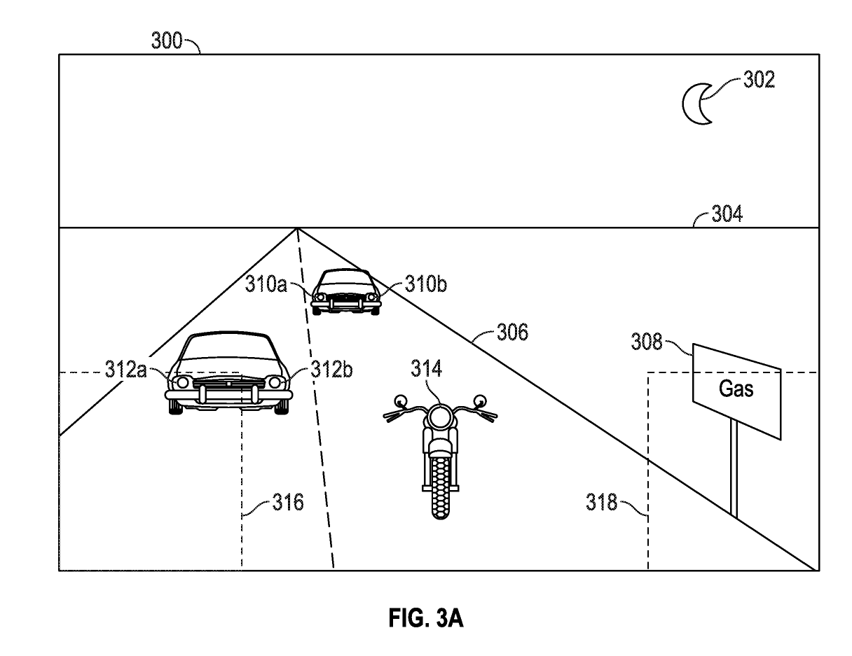

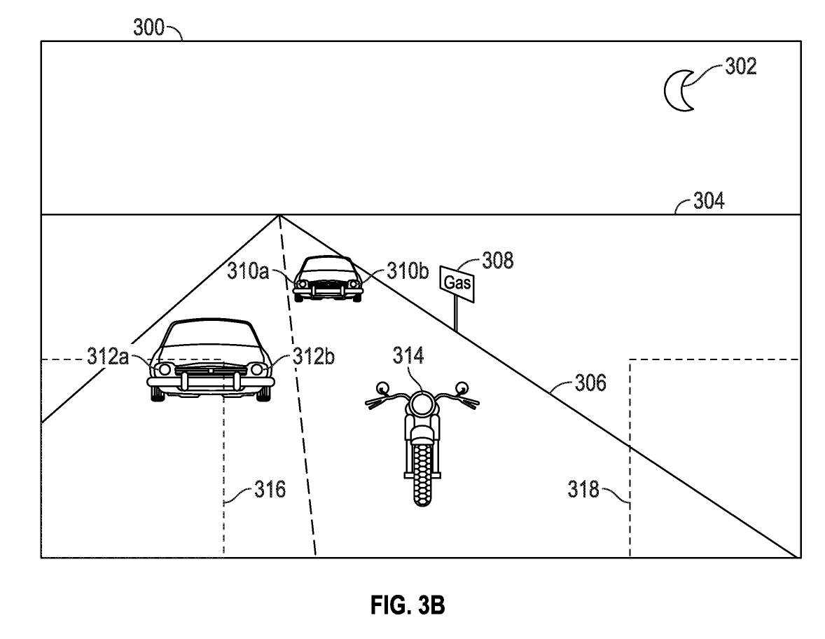

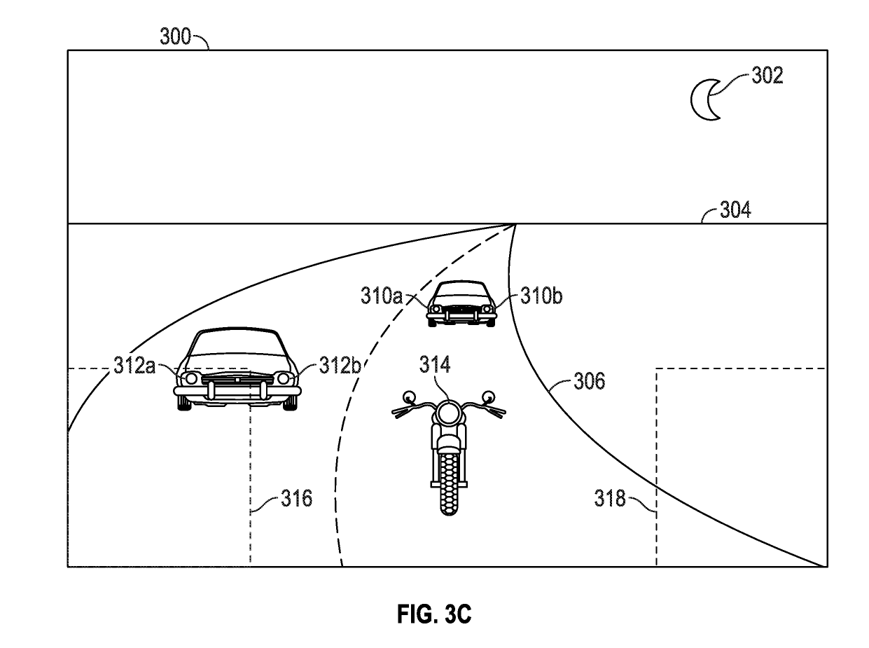

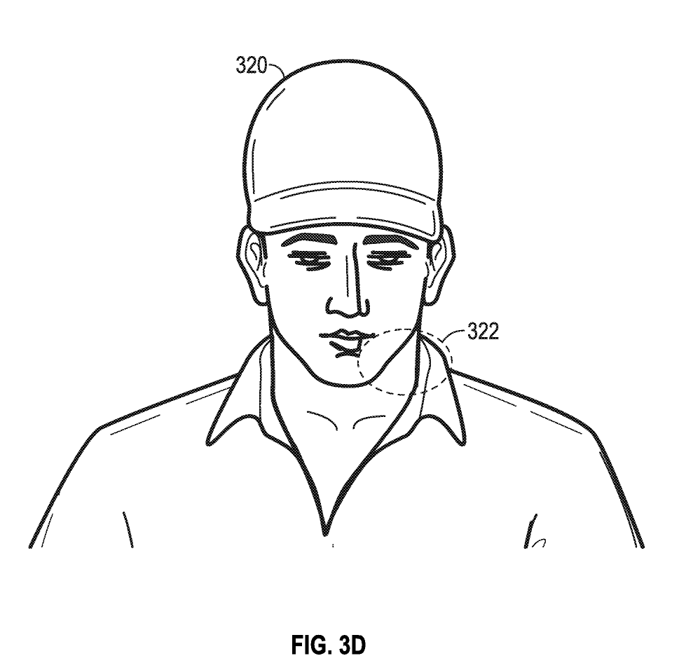

FIG. 2 illustrates an exemplary vehicle 200 that does not include a rear view mirror according to examples of the disclosure. Vehicle 200 can be any kind of vehicle, such as a consumer automobile, an airplane, a boat, or an industrial automobile. Vehicle 200 can include left side view mirror 202 and ride side view mirror 204, as described with reference to FIG. 1, though vehicle may not include a rear view mirror. In lieu of a rear view mirror, and in addition to side view mirrors 202 and 204, vehicle 200 can include one or more cameras for capturing images of the vehicle's surroundings, which can be transmitted to one or more displays inside the vehicle for the driver's reference. For example, vehicle 200 can include camera 206, which can capture images to the left and behind the vehicle (e.g., corresponding to a region visible from side view mirror 202), camera 210, which can capture images to the right and behind the vehicle (e.g., corresponding to a region visible from side view mirror 204), and camera 208, which can capture images behind the vehicle (e.g., corresponding to a region visible from a rear view mirror, if the vehicle had such a mirror). In some examples, cameras 206, 208 and 210 can have relatively narrow fields of view (e.g., 120 degrees or less); thus, in some examples, vehicle 200 can also include camera 212, which can provide relatively wide field of view (e.g., 180 degrees or more) images of the vehicle's rear/sides for use in parking operations, for example. It should be understood that the locations of cameras 206, 208, 210, 212 as shown in FIG. 3A are only illustrative. The cameras can be placed anywhere on the vehicle so long as to capture the desired view.

Because vehicle 200 can optionally have side view mirrors 202 and 204, but may not have a rear view mirror such as mirror 106 in FIG. 1 in which an optoelectronic diode can be integrated to sense trailing headlights, vehicle 200 can utilize one or more of cameras 206, 208, 210 and 212 to identify headlights that might reflect off of side view mirrors 202 and 204 to cause glare to the driver of the vehicle. Vehicle 200 can then dim one or more of side view mirrors 202 and 204, as appropriate, based on the images captured by one or more of cameras 206, 208, 210 and 212, as will be described in more detail below.

FIGS. 3A-3C illustrate exemplary composite images 300 captured by one or more of cameras 206, 208, 210 and 212 in FIG. 2 according to examples of the disclosure. For example, image 300 can represent images captured by cameras 206, 208 and 210 of areas behind the vehicle. It is understood that while the examples of the disclosure are described in the context of a composite image sourced from multiple cameras, in some examples, the image processing techniques disclosed below can be separately implemented on images captured by individual cameras. For example, image processing techniques described with reference to the left side of image 300 can be performed on images captured by camera 210 (e.g., corresponding to the rear-right of the vehicle) without generating composite image 300.

As illustrated in FIG. 3A, the vehicle can be driving on road 306 in the evening (e.g., in the dark), and the portion of road 306 behind the vehicle can be shown in image 300. Road 306 can disappear into horizon 304 in the distance. Moon 302 can also be behind the vehicle, and above horizon 304. Sign 308, which can be an illuminated sign, can be positioned by the side of road 306, as shown. Multiple headlights (e.g., from trailing cars, not illustrated) can also be visible on road 306. For example, headlights 310A, 310B and 312A, 312B from trailing automobiles, and headlight 314 from a trailing motorcycle, can be visible in image 300.

In some examples, the vehicle may only dim its side mirrors in response to detecting headlights in image 300, and not in response to detecting other sources of light. Further, the vehicle may assume that headlights will appear within the boundaries of road 306 in image 300, and not outside of those boundaries. Thus, in some examples, the vehicle can identify the boundaries of road 306 and/or horizon 304, and identify sources of light that are outside of the boundaries of road 306 (or outside a predetermined distance of road 306) and/or above horizon 304 as not being headlights, and, thus, as not triggering dimming of its side mirrors. Analogously, the vehicle can identify headlights 310A, 310B, 312A, 312B and 314 as being headlights, and thus potentially triggering dimming of its side view mirrors, because headlights 310A, 310B, 312A, 312B and 314 can be located within the boundaries of road 306 and below horizon 304 in image 300.

In some examples, in addition or alternatively to using road 306 and/or horizon 304 as boundaries or as defining regions in image 300 to identify headlights, the vehicle can analyze the characteristics of various light sources in the image to identify light sources as being headlights or not. For example, headlights may appear like point sources of light in image 300, while other sources of light (e.g., moon 302 and/or sign 308) may not appear as point sources of light. Therefore, the vehicle can identify moon 302 and sign 308 as not being point sources of light (and, thus, not headlights), and can identify headlights 310A, 310B, 312A, 312B and 314 as being point sources of light (and, thus, headlights). In some examples, the vehicle may additionally or alternatively search for pairs of point sources of light in image 300, as would be the case for automobiles with two headlights, in identifying sources of light as being headlights or not. For example, the cameras can take a series of images over a period of time. An image processor in the vehicle can process the images to determine the relative positions of the two sources of light in these images and then determine whether the two sources of light are indeed headlights based on the relative positions. Accordingly, the vehicle can identify headlights 310A, 310B, 312A and 312B as being headlights, and can identify moon 302 and sign 308 (and, perhaps, headlight 314) as not being headlights.

In some examples, not all sources of light that are identified as headlights may cause the vehicle to dim its side mirrors. Specifically, headlights that are not positioned such that they would reflect off of the vehicle's side view mirrors and into the driver's eyes may not cause glare for the driver of the vehicle, and thus, may not trigger dimming of the vehicle's side view mirrors. Therefore, in some examples, the vehicle can determine whether the sources of light it has identified as headlights are located within specified regions with respect to the vehicle (e.g., regions in image 300 that correspond to regions in the vehicle's surroundings that are visible to the driver from the vehicle's side view mirrors). For example, the vehicle can determine whether headlights 310A, 310B, 312A, 312B and 314, after identifying them as headlights, are located within region 316 (corresponding to an area that may cause glare via the vehicle's right side view mirror) or region 318 (corresponding to an area that may cause glare via the vehicle's left side view mirror) in image 300. The vehicle can determine that headlight 312A is located within region 316 of image 300, as shown in FIG. 3A. As a result, the vehicle can determine that headlight 312A is likely to cause glare for the driver of the vehicle, and can dim its side view mirrors based on the intensity of headlight 312A. In some examples, the vehicle can independently dim its right side view mirror in response to detecting headlight 312A in region 316, but not dim its left side view mirror in response to detecting headlight 312A in region 316 (e.g., because no headlight is detected in region 318). In some examples, in response to detecting different headlights in regions 316 and 318 of image 300, the vehicle can dim its right and left side view mirrors by different amounts based on the characteristics (e.g., intensities) of the headlights detected in those regions.

In some examples, in addition or alternatively to identifying headlights in image 300 as described above, the vehicle can identify sources of light as being headlights or not based on their movements in image 300. For example, street lights may enter image 300 from the top right and left corners of the image, and can move towards the center of the image over time, while headlights from other cars may not exhibit such behavior. Additionally or alternatively, headlights from trailing vehicles can move less than a threshold distance within image 300 over a given amount of time (e.g., because trailing vehicles can be moving at close to the same speed as the vehicle), while lights from road signs or street lights can move greater than the threshold distance within the image over the given amount of time (e.g., because road signs or street lights can be stationary, while the vehicle can be moving). For example, FIG. 3B illustrates image 300 after a predetermined amount of time has elapsed since FIG. 3A (i.e., the vehicle has moved further down road 306). Sign 308 has moved a relatively large distance in image 300 (e.g., greater than a threshold distance), while headlights 310A, 310B, 312A, 312B and 314 have moved relatively small distances in image 300 (e.g., less than the threshold distance). As such, the vehicle can identify sign 308 as not being a headlight.

In some examples, the region(s) in image 300 that the vehicle associates with headlights can change as a function of the characteristics of the road on which the vehicle is traveling. For example, FIG. 3C illustrates image 300 when the vehicle is on a curved road 306. Similar to as discussed with reference to FIG. 3A, the vehicle can search for sources of light that are below horizon 304 and/or within the boundaries of road 306 to (potentially) identify such sources of light as headlights, while identifying sources of light above horizon 304 and/or outside of the boundaries of road 306 as not being headlights. However, the boundaries of road 306 in FIG. 3C can be at different locations in image 300 than the boundaries of road 306 in FIG. 3A, because road 306 can be a curved road in FIG. 3C. Therefore, the vehicle can, using appropriate image processing techniques, identify the boundaries of road 306 in FIG. 3C, and can designate the region in image 300 corresponding to the area within the boundaries of road 306 as being the region in which sources of light can (potentially) be identified as headlights. This region can be different than the corresponding region in image 300 in FIG. 3A. In some examples, the vehicle can additionally or alternatively determine these different regions in image 300 based on detecting the steering angle of the vehicle (indicating the vehicle is driving on a curved road), based on the GPS coordinates of the vehicle (indicating, on a map, that the vehicle is on a curved road) and/or based on image processing of image 300 or images from other cameras on the vehicle, such as front-facing cameras (determining, via image processing, that the vehicle is on a curved road).

In some examples, the vehicle can include one or more interior cameras that can be used for applications such as video conferencing or driver/passenger identification using facial recognition. In some examples, the vehicle can utilize these one or more interior cameras to determine whether light reflected from the vehicle's side mirrors is incident on the driver's face, and can control dimming of its side view mirrors accordingly. FIG. 3D illustrates an example face 320 of the driver of the vehicle according to examples of the disclosure. The vehicle can, using one or more interior cameras and facial recognition techniques, identify the face of the driver of the vehicle. Then, the vehicle can determine whether light (e.g., light reflected from the vehicle's side view mirrors) is incident on the driver's face 320 or eyes. For example, the vehicle can search for an area of light around the driver's face that has a shape that corresponds to the shapes of the vehicle's side view mirrors. In FIG. 3D, such light is illustrated as light 322. The vehicle can then determine whether light 322 overlaps with the driver's face 320. In FIG. 3D, light 322 does overlap with the driver's face, so the vehicle can determine that one or both of its side view mirrors should be dimmed. In some examples, the vehicle may not make such as determination unless light 322 overlaps with one or more of the driver's eyes, or is within a predetermined distance of the driver's eyes, in which case the vehicle can determine that one or both of its side view mirrors should be dimmed.

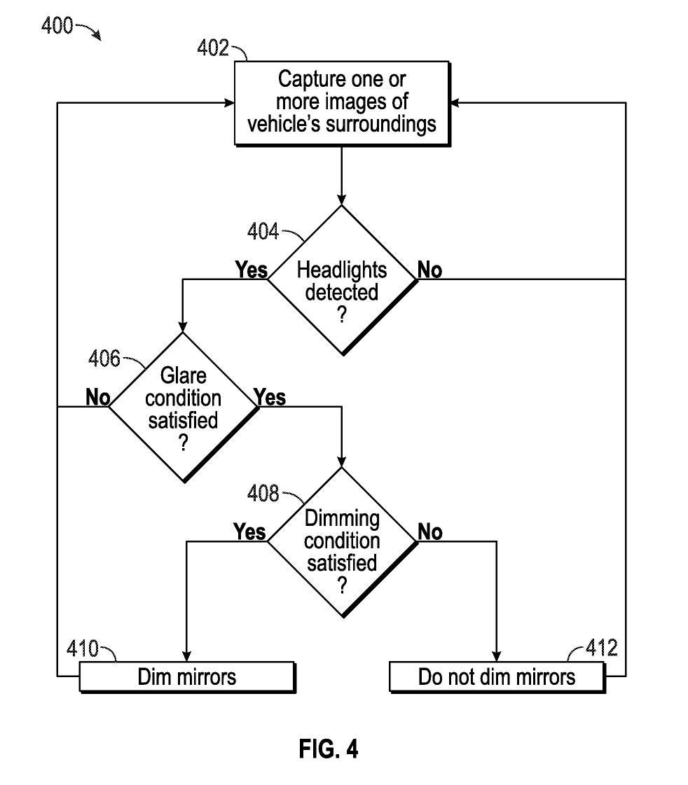

FIG. 4 illustrates an exemplary method 400 for dimming the side view mirrors of a vehicle based on images captured by one or more cameras according to examples of the disclosure. In some examples, method 400 is only performed while the vehicle's surroundings are dark (e.g., include less than a threshold amount of ambient light), and/or during specified hours of the day (e.g., between the hours of sunset and sunrise), because glare caused by headlights might not otherwise be an issue for the driver. In some examples, the vehicle can measure the ambient light in its surroundings using a light sensor on the vehicle (e.g., a light sensor used to illuminate automatic headlights), or can use image processing techniques (e.g., analyzing the brightness of pixels above the horizon over time) on images captured by on-board cameras to determine the ambient light in the vehicle's surroundings. Other manners of determining the ambient light in the vehicle's surroundings can also be utilized. In some examples, method 400 can be performed irrespective of ambient light levels or the time of day.

At 402, one or more images of the vehicle's surroundings can be captured using one or more cameras on the vehicle, such as described with reference to FIGS. 2 and 3A-3C. At 404, whether or not headlights are detected in the captured images can be determined, such as described with reference to FIGS. 3A-3C. In some examples, one or more of the methods for identifying sources of light as headlights described with reference to FIGS. 3A-3C can be employed by the vehicle at step 404. Additionally or alternatively, the vehicle can identify vehicle headlights as such based on analyzing the frequencies (e.g., flicker frequencies) of the light sources in the images. Sun light/natural light and street lights might have different frequencies of operation than vehicle headlights, which can be DC or flicker at specified frequencies. Therefore, the vehicle can identify the frequencies of operation of the light sources within the images, and can identify the light sources as being headlights or not based on those frequencies.

If no headlights are detected in the images at 404, method 400 can return to step 402 to capture additional images of the vehicle's surroundings. If headlights are detected in the images at 404, whether a glare condition is satisfied can be determined at 406, such as described with reference to FIGS. 3A-3D. For example, if the headlights are detected within given regions in the images corresponding to the vehicle's side view mirrors, and/or if image processing from interior cameras on the vehicle identifies reflected light incident on the driver's face, the vehicle can determine that the headlights are likely to cause glare for the driver of the vehicle, and the glare condition can be satisfied. Other manners for determining whether a given headlight will cause glare for the driver described with reference to FIGS. 3A-3D can be implemented at step 406. Additionally or alternatively to the techniques described with reference to FIGS. 3A-3D, whether a given light source satisfies the glare condition can depend on whether the brightness of that light source, in the images, is greater than (satisfying the glare condition) or less than (not satisfying the glare condition) a pixel brightness threshold. In some examples, this pixel brightness threshold can be automatically adjusted by the vehicle based on the ambient lighting conditions around the vehicle. For example, the brighter the ambient lighting is around the vehicle, the higher this pixel brightness threshold can be, and vice versa.

If the glare condition is not satisfied at 406, method 400 can return to step 402. If the glare condition is satisfied at 406, whether a dimming condition is satisfied can be determined at 408, such as described with reference to FIGS. 3A-3D. For example, the vehicle may not dim its side view mirrors in response to every light source it detects that satisfies the glare condition at 406. Rather, the vehicle may only determine that the dimming condition is satisfied (e.g., and thus, trigger dimming of its side view mirrors) when the glare condition has been continuously satisfied for longer than a predetermined time period (or for more than a predetermined number of image frames) to avoid mirror dimming behavior that fluctuates rapidly (e.g., dimming for one second, followed by not dimming for one second, etc.).

If the dimming condition is not satisfied at 408, method 400 can determine to not dim the side view mirrors at 412, and can return to step 402. If the dimming condition is satisfied at 408, method 400 can proceed to step 410 where the vehicle can dim its side view mirrors, such as discussed with reference to FIGS. 3A-3D. Additionally or alternatively, in some examples, the amount of dimming of the vehicle's side view mirrors can be dynamic and/or variable. For example, the brighter the headlights in the images are, or the greater the brightness of the headlights is above the pixel brightness threshold discussed with reference to step 406, the more the vehicle can dim its side view mirrors. In some examples, the amount of side view mirror dimming can depend on the distance of the detected headlights from the vehicle. For example, the further away the headlights are, the less the vehicle can dim its side view mirrors. In some examples, the vehicle can determine the distance of the headlights from the vehicle based on the distance between pairs of headlights it identifies in the images. Specifically, the vehicle can assume that an automobile's headlights are separated from each other by a specified distance (or by a maximum distance, such as the width of a lane of a road, or an average distance between automobile headlights). By comparing this specified distance with the distance between the headlights in the captured images, the vehicle can determine the distance of the headlights from the vehicle (e.g., using trigonometric relationships between distance from the vehicle and distance between headlight pairs); the further away the headlights are, the closer together they can appear in the captured images, and vice versa.

In some examples, the windows of the vehicle can be tinted, while the cameras that capture the images at step 402 can be external to the vehicle (and thus may not capture those images through the window tint). As a result, the brightness of headlights perceived by the driver of the vehicle can be different from the brightness of the headlights perceived by the cameras. In such situations, the dimming system of the vehicle can adjust itself (e.g., pixel brightness thresholds can be adjusted) to account for the reduction in light transmission into the interior of the vehicle caused by the window tint on the vehicle. For example, the darker the window tinting is, the greater the pixel brightness thresholds that are utilized by the vehicle can be (or the less dimming of the side view mirrors can be performed), and vice versa.

After dimming the side view mirrors at step 410, method 400 can return to step 402.

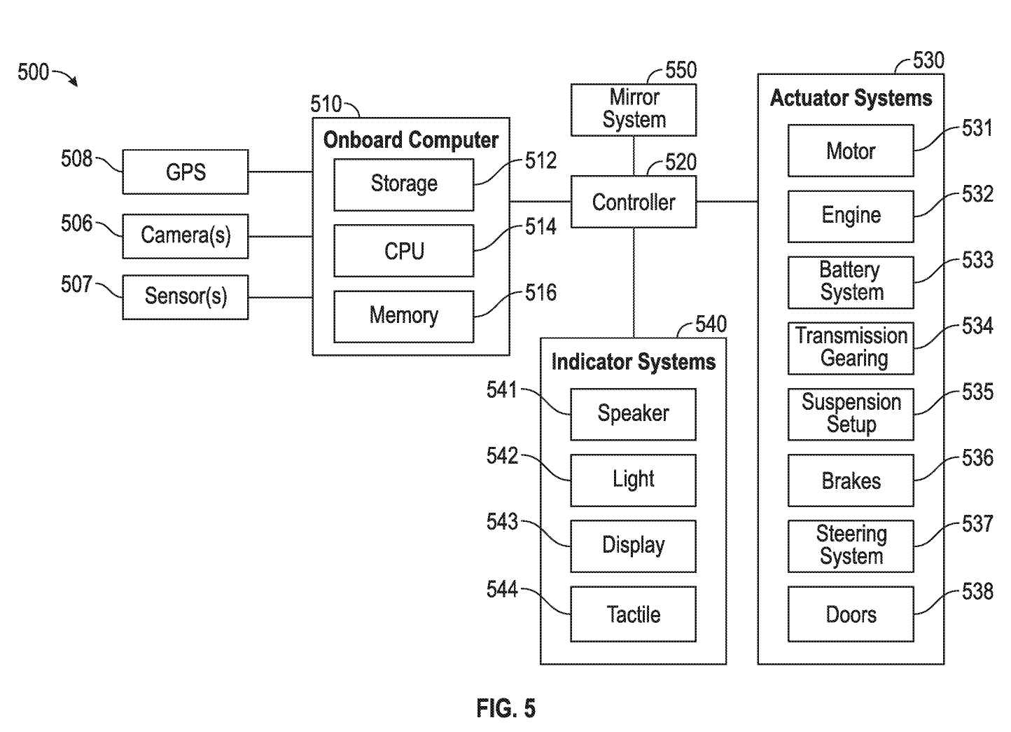

FIG. 5 illustrates an exemplary system block diagram of vehicle control system 500 according to examples of the disclosure. Vehicle control system 500 can perform any of the methods described with reference to FIGS. 1-4. System 500 can be incorporated into a vehicle, such as a consumer automobile. Other example vehicles that may incorporate the system 500 include, without limitation, airplanes, boats, or industrial automobiles. Vehicle control system 500 can include one or more cameras 506 capable of capturing image data (e.g., video data) of the vehicle's surroundings, as described with reference to FIGS. 1-4. Vehicle control system 500 can also include one or more other sensors 507 (e.g., radar, ultrasonic, LIDAR, etc.) capable of detecting various characteristics of the vehicle's surroundings, and a Global Positioning System (GPS) receiver 508 capable of determining the location of the vehicle. Vehicle control system 500 can include an on-board computer 510 that is coupled to the cameras 506, sensors 507 and GPS receiver 508, and that is capable of receiving the image data from the cameras and/or outputs from the sensors 507 and the GPS receiver 508. The on-board computer 510 can be capable of identifying headlights trailing the vehicle and dimming mirrors on the vehicle (e.g., side view mirrors), as described in this disclosure. On-board computer 510 can include storage 512, memory 516, and a processor 514. Processor 514 can perform any of the methods described with reference to FIGS. 1-4. Additionally, storage 512 and/or memory 516 can store data and instructions for performing any of the methods described with reference to FIGS. 1-4. Storage 512 and/or memory 516 can be any non-transitory computer readable storage medium, such as a solid-state drive or a hard disk drive, among other possibilities. The vehicle control system 500 can also include a controller 520 capable of controlling one or more aspects of vehicle operation, such as dimming one or more mirrors (e.g., side view mirrors) as determined by the on-board computer 510.

In some examples, the vehicle control system 500 can be connected to (e.g., via controller 520) one or more actuator systems 530 in the vehicle, one or more indicator systems 540 in the vehicle and a mirror system 550 in the vehicle. The one or more actuator systems 530 can include, but are not limited to, a motor 531 or engine 532, battery system 533, transmission gearing 534, suspension setup 535, brakes 536, steering system 537 and door system 538. The vehicle control system 500 can control, via controller 520, one or more of these actuator systems 530 during vehicle operation; for example, to open or close one or more of the doors of the vehicle using the door actuator system 538, to control the vehicle during autonomous driving or parking operations using the motor 531 or engine 532, battery system 533, transmission gearing 534, suspension setup 535, brakes 536 and/or steering system 537, etc. The one or more indicator systems 540 can include, but are not limited to, one or more speakers 541 in the vehicle (e.g., as part of an entertainment system in the vehicle), one or more lights 542 in the vehicle, one or more displays 543 in the vehicle (e.g., as part of a control or entertainment system in the vehicle) and one or more tactile actuators 544 in the vehicle (e.g., as part of a steering wheel or seat in the vehicle). The vehicle control system 500 can control, via controller 520, one or more of these indicator systems 540 to provide indications to a driver of the vehicle of one or more characteristics of the vehicle's surroundings that are determined by the on-board computer 510, such as the existence and/or brightness of trailing headlights.

The mirror system 550 can include dimmable (e.g., electrochromic mirrors), mirrors, such as side view mirrors on the vehicle. The on-board computer 510 can, via controller 520, control the amount of dimming of the mirrors in the mirror system 550, as described in this disclosure.

Thus, the examples of the disclosure provide various ways to control the dimming of mirrors on a vehicle using one or more cameras on the vehicle.

Therefore, according to the above, some examples of the disclosure are directed to a vehicle comprising: one or more dimmable mirrors; one or more cameras configured to capture images of surroundings of the vehicle; and one or more processors coupled to the one or more dimmable mirrors and the one or more cameras, the one or more processors configured to: identify one or more headlights of another vehicle in the captured images; determine whether the one or more headlights satisfy mirror dimming criteria, including a criterion that is satisfied when the one or more headlights are located in a respective region of the captured images; in accordance with a determination that the one or more headlights satisfy the mirror dimming criteria, dim the one or more dimmable mirrors based on one or more characteristics of the one or more headlights; and in accordance with a determination that the one or more headlights do not satisfy the mirror dimming criteria, forgo dimming the one or more dimmable mirrors. Additionally or alternatively to one or more of the examples disclosed above, in some examples, the one or more dimmable mirrors include one or more side view mirrors. Additionally or alternatively to one or more of the examples disclosed above, in some examples, the vehicle does not include a rear view mirror, and at least one of the one or more cameras performs functionality of the rear view mirror. Additionally or alternatively to one or more of the examples disclosed above, in some examples, the surroundings of the vehicle comprise the rear surroundings of the vehicle. Additionally or alternatively to one or more of the examples disclosed above, in some examples, identifying the one or more headlights of another vehicle comprises identifying a light source as a headlight in accordance with a determination that the light source is a point source. Additionally or alternatively to one or more of the examples disclosed above, in some examples, identifying the one or more headlights of another vehicle comprises identifying a light source as a headlight in accordance with a determination that movement of the light source in the images over time has specified characteristics. Additionally or alternatively to one or more of the examples disclosed above, in some examples, the movement of the light source in the images over time has the specified characteristics when the light source moves less than a threshold distance during a threshold time. Additionally or alternatively to one or more of the examples disclosed above, in some examples, identifying the one or more headlights of another vehicle comprises identifying a light source as a headlight in accordance with a determination that the light source is located in a specified region in the images. Additionally or alternatively to one or more of the examples disclosed above, in some examples, the specified region comprises a road in the images. Additionally or alternatively to one or more of the examples disclosed above, in some examples, the specified region comprises a region below a horizon in the images. Additionally or alternatively to one or more of the examples disclosed above, in some examples, the specified region in the images changes as a function of one or more characteristics of a road on which the vehicle is traveling. Additionally or alternatively to one or more of the examples disclosed above, in some examples, the one or more processors are configured to determine the one or more characteristics of the road based on at least one of a steering angle of the vehicle, a GPS location of the vehicle, and image processing of the images. Additionally or alternatively to one or more of the examples disclosed above, in some examples, the respective region in the captured images corresponds to a region with respect to the vehicle that is visible to the driver via at least one of the one or more dimmable mirrors. Additionally or alternatively to one or more of the examples disclosed above, in some examples, the mirror dimming criteria include a criterion that is satisfied when the vehicle determines, using an interior camera of the vehicle, that light reflected from the one or more dimmable mirrors is incident on a face of a driver of the vehicle. Additionally or alternatively to one or more of the examples disclosed above, in some examples, the mirror dimming criteria include a criterion that is satisfied when the one or more headlights are located in the respective region of the captured images for longer than a predetermined time. Additionally or alternatively to one or more of the examples disclosed above, in some examples, the mirror dimming criteria include a criterion that is satisfied when an amount of ambient light in the surroundings of the vehicle is less than a threshold amount. Additionally or alternatively to one or more of the examples disclosed above, in some examples, the mirror dimming criteria include a criterion that is satisfied when a brightness of the one or more headlights in the captured images is greater than a brightness threshold. Additionally or alternatively to one or more of the examples disclosed above, in some examples, the brightness threshold changes as a function of an amount of ambient light in the surroundings of the vehicle. Additionally or alternatively to one or more of the examples disclosed above, in some examples, the brightness threshold is based on an amount of window tinting on the vehicle. Additionally or alternatively to one or more of the examples disclosed above, in some examples, the one or more characteristics of the one or more headlights comprise a distance of the one or more headlights from the vehicle. Additionally or alternatively to one or more of the examples disclosed above, in some examples, the one or more processors are configured to determine the distance of the one or more headlights from the vehicle based on a distance between a pair of headlights in the one or more headlights. Additionally or alternatively to one or more of the examples disclosed above, in some examples, the one or more processors are configured to: independently dim a first mirror of the one or more dimmable mirrors and a second mirror of the one or more dimmable mirrors.

Some examples of the disclosure are directed to a method comprising: capturing images of surroundings of a vehicle, the vehicle including one or more dimmable mirrors; identifying one or more headlights of another vehicle in the captured images; determining whether the one or more headlights satisfy mirror dimming criteria, including a criterion that is satisfied when the one or more headlights are located in a respective region of the captured images; in accordance with a determination that the one or more headlights satisfy the mirror dimming criteria, dimming the one or more dimmable mirrors based on one or more characteristics of the one or more headlights; and in accordance with a determination that the one or more headlights do not satisfy the mirror dimming criteria, forgoing dimming the one or more dimmable mirrors.

Some examples of the disclosure are directed to a non-transitory computer-readable medium including instructions, which when executed by one or more processors, cause the one or more processors to perform a method comprising: capturing images of surroundings of a vehicle, the vehicle including one or more dimmable mirrors; identifying one or more headlights of another vehicle in the captured images; determining whether the one or more headlights satisfy mirror dimming criteria, including a criterion that is satisfied when the one or more headlights are located in a respective region of the captured images; in accordance with a determination that the one or more headlights satisfy the mirror dimming criteria, dimming the one or more dimmable mirrors based on one or more characteristics of the one or more headlights; and in accordance with a determination that the one or more headlights do not satisfy the mirror dimming criteria, forgoing dimming the one or more dimmable mirrors.

Although examples of this disclosure have been fully described with reference to the accompanying drawings, it is to be noted that various changes and modifications will become apparent to those skilled in the art. Such changes and modifications are to be understood as being included within the scope of examples of this disclosure as defined by the appended claims.

1. A vehicle comprising:
one or more dimmable mirrors;
one or more cameras configured to capture images of surroundings of the vehicle; and
one or more processors coupled to the one or more dimmable mirrors and the one or more cameras, the one or more processors configured to:
identify one or more headlights of another vehicle in the captured images;
determine whether the one or more headlights satisfy mirror dimming criteria, including a criterion that is satisfied when the one or more headlights are located in a respective region of the captured images;
in accordance with a determination that the one or more headlights satisfy the mirror dimming criteria, dim the one or more dimmable mirrors based on one or more characteristics of the one or more headlights; and
in accordance with a determination that the one or more headlights do not satisfy the mirror dimming criteria, forgo dimming the one or more dimmable mirrors.

2. The vehicle of claim 1, wherein the one or more dimmable mirrors include one or more side view mirrors.

3. The vehicle of claim 2, wherein the vehicle does not include a rear view mirror, and at least one of the one or more cameras performs functionality of the rear view mirror.

4. The vehicle of claim 1, wherein the surroundings of the vehicle comprise the rear surroundings of the vehicle.

5. The vehicle of claim 1, wherein identifying the one or more headlights of another vehicle comprises identifying a light source as a headlight in accordance with a determination that the light source is a point source.

6. The vehicle of claim 1, wherein identifying the one or more headlights of another vehicle comprises identifying a light source as a headlight in accordance with a determination that movement of the light source in the images over time has specified characteristics.

7. The vehicle of claim 6, wherein the movement of the light source in the images over time has the specified characteristics when the light source moves less than a threshold distance during a threshold time.

8. The vehicle of claim 1, wherein identifying the one or more headlights of another vehicle comprises identifying a light source as a headlight in accordance with a determination that the light source is located in a specified region in the images.

9. The vehicle of claim 8, wherein the specified region comprises a road in the images.

10. The vehicle of claim 8, wherein the specified region comprises a region below a horizon in the images.

11. The vehicle of claim 8, wherein the specified region in the images changes as a function of one or more characteristics of a road on which the vehicle is traveling.

12. The vehicle of claim 11, wherein the one or more processors are configured to determine the one or more characteristics of the road based on at least one of a steering angle of the vehicle, a GPS location of the vehicle, and image processing of the images.

13. The vehicle of claim 1, wherein the respective region in the captured images corresponds to a region with respect to the vehicle that is visible to the driver via at least one of the one or more dimmable mirrors.

14. The vehicle of claim 1, wherein the mirror dimming criteria include a criterion that is satisfied when the vehicle determines, using an interior camera of the vehicle, that light reflected from the one or more dimmable mirrors is incident on a face of a driver of the vehicle.

15. The vehicle of claim 1, wherein the mirror dimming criteria include a criterion that is satisfied when the one or more headlights are located in the respective region of the captured images for longer than a predetermined time.

16. The vehicle of claim 1, wherein the mirror dimming criteria include a criterion that is satisfied when an amount of ambient light in the surroundings of the vehicle is less than a threshold amount.

17. The vehicle of claim 1, the mirror dimming criteria include a criterion that is satisfied when a brightness of the one or more headlights in the captured images is greater than a brightness threshold.

18. The vehicle of claim 17, wherein the brightness threshold changes as a function of an amount of ambient light in the surroundings of the vehicle.

19. The vehicle of claim 17, wherein the brightness threshold is based on an amount of window tinting on the vehicle.

20. A method comprising:
capturing images of surroundings of a vehicle, the vehicle including one or more dimmable mirrors;
identifying one or more headlights of another vehicle in the captured images;
determining whether the one or more headlights satisfy mirror dimming criteria, including a criterion that is satisfied when the one or more headlights are located in a respective region of the captured images;
in accordance with a determination that the one or more headlights satisfy the mirror dimming criteria, dimming the one or more dimmable mirrors based on one or more characteristics of the one or more headlights; and
in accordance with a determination that the one or more headlights do not satisfy the mirror dimming criteria, forgoing dimming the one or more dimmable mirrors.
